(19) United States
(12) Patent Application Publication
(10) Pub. No.: US 2012/0038672 A1
(43) Pub. Date: Feb. 16, 2012

(54) MOBILE DEVICE HAVING PROJECTOR MODULE AND METHOD FOR OUTPUTTING IMAGES IN THE MOBILE DEVICE

(75) Inventor: Yo Ywang IM, Suwon-si (KR)

(73) Assignee: SAMSUNG ELECTRONICS CO. LTD., Suwon-si (KR)

(21) Appl. No.: 13/205,905

(22) Filed: Aug. 9, 2011

(30) Foreign Application Priority Data
Aug. 11, 2010 (KR) 10-2010-0077182

(51) Int. Cl. G09G 5/00; G06F 3/038

(52) U.S. Cl. 345/636; 345/204

(57) ABSTRACT

A mobile device and method for efficiently outputting images through a projector module are provided. The mobile device includes a projector module for outputting image frames that constitute image content, and a display unit for outputting a manipulation User Interface (UI) for manipulating the image content. The mobile device further includes a display driver for updating the image frames through the projector module, and for updating the manipulation UI through the display unit whenever a UI update command is received. Additionally, the mobile device further includes a control unit for sending an image frame update command and the UI update command to the display driver, and for controlling the display driver such that a process of updating the manipulation UI through the display unit is stopped when a turn-off command for the display unit is inputted.

### PRIORITY

This application claims the benefit under 35 U.S.C. §119(a) of a Korean patent application filed on Aug. 11, 2010 in the Korean Intellectual Property Office and assigned Serial No. 10-2010-0077182, the entire disclosure of which is hereby incorporated by reference.

### BACKGROUND OF THE INVENTION

1. Field of the Invention

The present invention relates to image output technology for a mobile device having a projector module. More particularly, the present invention relates to a mobile device and method for efficiently outputting images through a projector module.

2. Description of the Related Art

With the remarkable growth of related technologies, a great variety of mobile devices are becoming increasingly popular. Mobile devices not only provide a voice call service, but also may optionally offer a data transmission service as well as other various additional services, thereby evolving into multimedia communication devices.

Recently, mobile devices with a built-in projector module have been developed. This mobile device can project images onto a surface such as a projection screen or a wall through the projector module, thus allowing many persons to simultaneously view image contents (e.g., photo contents, video contents, etc.) stored in the mobile device.

This type of mobile device drives a dedicated player (e.g., a DivX player) equipped therein and then outputs image contents through the projector module. At this time, the mobile device updates and outputs real-time image frames. However, since the mobile device has restricted hardware in comparison with a typical stand-alone projector, the mobile device is relatively poor at updating image frames to the projector module. Therefore, there is a need for improving the performance of the mobile device in connection with a function to output images through the projector module.

### SUMMARY OF THE INVENTION

Aspects of the present invention are to address at least the above-mentioned problems and/or disadvantages and to provide at least the advantages described below. Accordingly, an aspect of the present invention is to provide a method for improving the performance of a mobile device with relatively restricted hardware in connection with a function to output images through the projector module.

Another aspect of the present invention is to provide a mobile device supporting the above method.

According to one aspect of the present invention, a mobile device is provided. The mobile device includes a projector module for outputting image frames that constitute image content, a display unit for outputting a manipulation User Interface (UI) for manipulating the image content, a display driver for updating the image frames through the projector module, and for updating the manipulation UI through the display unit whenever a UI update command is received, and a control unit for sending an image frame update command and the UI update command to the display driver, and for controlling the display driver such that a process of updating the manipulation UI through the display unit is stopped when a turn-off command for the display unit is inputted.

According to another aspect of the present invention, a mobile device is provided. The mobile device includes a projector module for outputting image frames and captions, both of which constitute image content, a display driver for receiving a plurality of layers, and for updating a frame layer among the received layers or for merging and updating the frame layer and a caption layer among the received layers, and a control unit for determining whether the caption is contained in a selected image to be outputted through the projector module, for sending a merging update command for the caption layer and the frame layer to the display driver when the caption is contained, and for sending a frame layer update command to the display driver when the caption is not contained.

According to still another aspect of the present invention, a method of outputting images in a mobile device that includes a projector module, a display unit and a display driver is provided. The method includes sending update commands when recognizing a play command for a selected image content, the sending of the update commands including sending image frames constituting the selected image content, an image frame update command, a manipulation UI, and a UI update command to the display driver, performing an update process at the display driver, the performing of the update process including updating the image frame by controlling the projector module, and updating the manipulation UI by controlling the display unit whenever the UI update command is received, and when recognizing a turn-off command for the display unit, stopping the updating of the manipulation UI through the display unit by controlling the display driver.

According to yet another aspect of the present invention, a method of outputting images in a mobile device that includes a projector module and a display driver is provided. The method includes determining whether a caption is contained in a selected image to be outputted through the projector module, sending a merging update command for a caption layer and a frame layer to the display driver when the caption is contained, or sending a frame layer update command to the display driver when the caption is not contained, and at the display driver, merging and updating the frame layer and the caption layer through the projector module when the merging update command is received, or updating the frame layer only through the projector module when the frame layer update command is received.

Aspects of the present invention may not only improve the output performance of the projector module, but also improve the decoding performance of the content playback controller. Additionally, aspects of the present invention may reduce undesirable load when the display driver outputs images through the display unit and the projector module, thus wholly enhancing the content playback performance of the mobile device. Therefore, aspects of the present invention may improve the image output performance of the mobile device with relatively restricted hardware.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a perspective view illustrating an external appearance of a mobile device having a projector module in accordance with an exemplary embodiment of the present invention.

FIG. 2 is a block diagram illustrating a configuration of a mobile device having a projector module in accordance with an exemplary embodiment of the present invention.

FIG. 3 is a block diagram illustrating a method for outputting images by means of related elements of a mobile device in accordance with an exemplary embodiment of the present invention.

FIG. 4 is a flow diagram illustrating a method for outputting images by means of a content playback controller of a mobile device in accordance with an exemplary embodiment of the present invention.

FIG. 5 is a flow diagram illustrating a method for outputting images by means of a content playback controller of a mobile device in accordance with an exemplary embodiment of the present invention.

FIG. 6 is a schematic diagram illustrating a method for outputting images with four layers by means of a display driver of a mobile device in accordance with an exemplary embodiment of the present invention.

FIG. 7 is a flow diagram illustrating a method for outputting images by means of a content playback controller of a mobile device in accordance with an exemplary embodiment of the present invention.

FIG. 8 is a schematic diagram illustrating a method for outputting images with four layers by means of a display driver of a mobile device in accordance with an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although a mobile device will be exemplarily described hereinafter, the present invention is not always limited to the mobile device. Alternatively, exemplary embodiments of the present invention may be applied to any other electronic device that has a projector module and a display unit. The mobile device according to exemplary embodiments of the present invention may include a mobile communication terminal, a Portable Multimedia Player (PMP), a Personal Digital Assistant (PDA), a smart phone, a Moving Picture Experts Group (MPEG)-1 or MPEG-2 Audio Layer 3 (MP3) player, and the like. Additionally, the mobile device of exemplary embodiments of the present invention may include an International Mobile Telecommunication 2000 (IMT-2000) device, a Wideband Code Division Multiple Access (WCDMA) device, a Global System for Mobile communication (GSM) device, a General Packet Radio Service (GPRS) device, a Universal Mobile Telecommunication Service (UMTS) device, and the like.

A disclosure set forth herein will be based on a mobile device that can output images, each of which is composed of at least one layer including a basic layer for offering backgrounds, a frame layer for offering image frames of image content, a caption layer for offering captions of image content, and a User Interface (UI) layer for offering UIs suitable for manipulating the playback of image content. The number of such layers may be determined depending on the performance of a processor. Parts of layers may be outputted through a projector module, whereas the others may be outputted through a display unit.

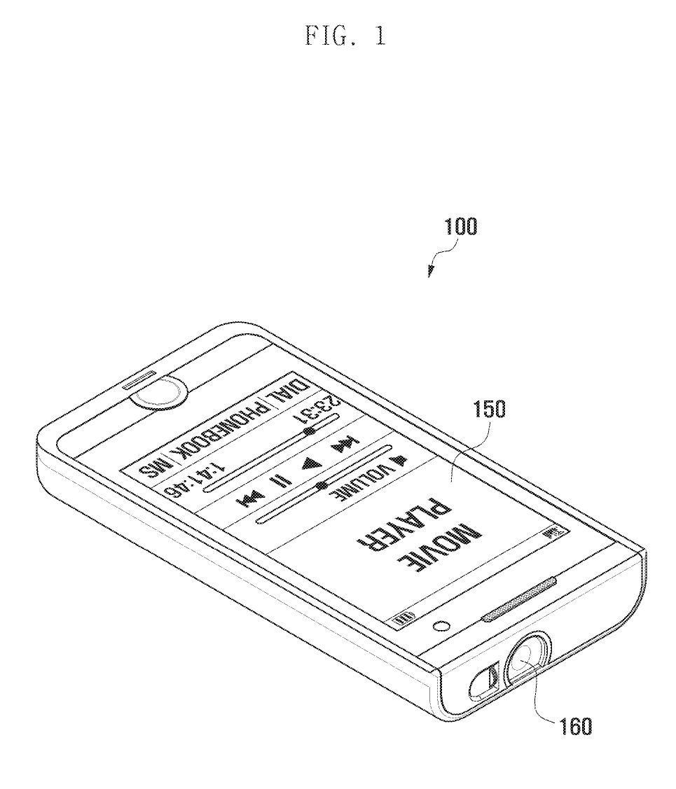

FIG. 1 is a perspective view illustrating an external appearance of a mobile device having a projector module according to an exemplary embodiment of the present invention.

Referring to FIG. 1, a mobile device 100 includes a display unit 150 and a projector module 160. The mobile device 100 shown in FIG. 1 is a touch screen based mobile device in which a touch panel is completely overlapped on the display unit 150. Preferably, the projector module 160 is disposed at the top side of the mobile device 100 so that a user can see a projected image while alternately seeing the display unit 150. In FIG. 1, the mobile device 100 is executing a ‘Movie Player’ application, for example, and hence the display unit 150 displays thereon an execution screen of the ‘Movie Player’ application. This execution screen offers a UI for manipulating the playback of image content, including a progress bar, a volume control bar, a play icon, a pause icon, a stop icon, a seek icon, etc. Now, respective elements of the mobile device 100 will be described in detail.

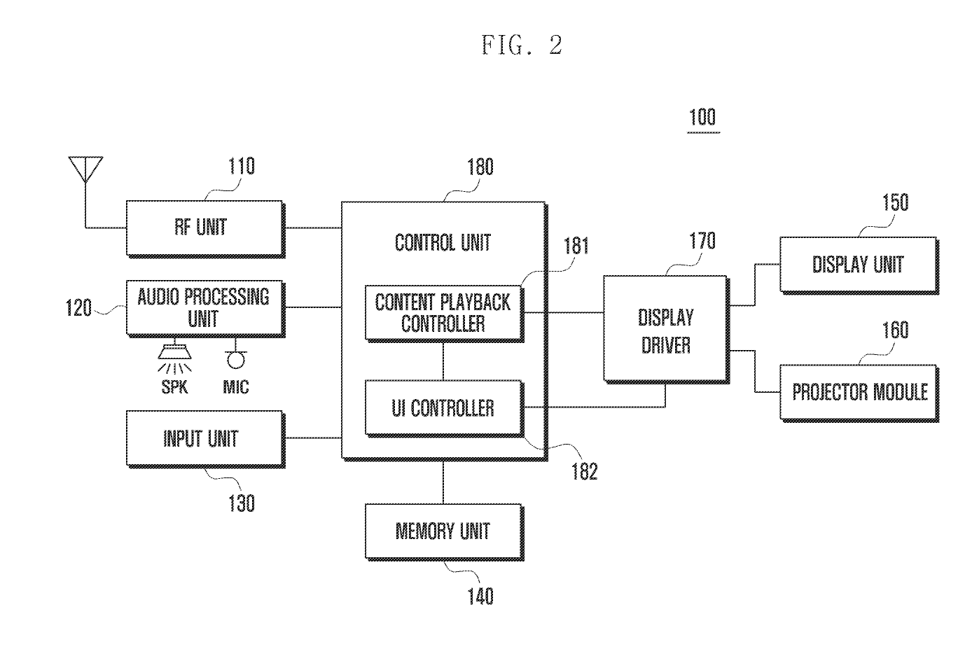

FIG. 2 is a block diagram illustrating a configuration of a mobile device having a projector module in accordance with an exemplary embodiment of the present invention.

Referring to FIG. 2, the mobile device 100 includes a Radio Frequency (RF) unit 110, an audio processing unit 120, an input unit 130, a memory unit 140, a display unit 150, a projector module 160, a display driver 170, and a control unit 180.

The RF unit 110 performs a function of transmitting and receiving data for a wireless communication of the mobile device 100. Normally the RF unit 110 may include an RF transmitter that up-converts the frequency of an outgoing signal and then amplifies the signal, an RF receiver that amplifies with low-noise an incoming signal and down-converts the frequency of the signal, and the like. Additionally, the RF unit 110 may receive data through a wireless channel and then output the data received through the wireless channel to the control unit 180, and also receive data from the control unit 180 and then transmit the data received from the control unit 180 through a wireless channel.

The audio processing unit 120 may include a codec which may be composed of a data codec for processing packet data and an audio codec for processing an audio signal such as voice. The audio processing unit 120 converts a digital audio signal into an analog audio signal through the audio codec and then outputs the analog audio signal through a speaker (SPK), and also convents an analog audio signal received from a microphone (MIC) into a digital audio signal through the audio codec.

The input unit 130 receives a user's key manipulation for controlling the mobile device 100, creates a corresponding input signal, and then delivers the corresponding input signal to the control unit 180. The input unit 130 may be formed of a keypad based on the 3*4 or QWERTY key layout and having alphanumeric keys and navigation keys. Alternatively or additionally, the input unit 130 may be formed of a touch panel. Depending on a user's input action, the input unit 130 creates various input signals for performing particular functions (e.g., a call function, a video or music playback function, an image display function, a broadcast receiving function, a camera function, a voice recording function, a function to execute a selected application such as a calculator or a scheduler) of the mobile device 100 and then sends the various input signals to the control unit 180. A disclosure set forth herein is based on the assumption that the input unit 130 is formed of a touch panel. In this case, the input unit 130 may further have a button key, a jog key, a wheel key, etc.

The memory unit 140 stores programs and data required for operations of the mobile device 100 and may consist of a program region and a data region. The memory unit 140 may be formed of a volatile memory such as a Random Access Memory (RAM), a non-volatile memory such as a flash memory or a hard disk, and their combinations.

The display unit 150 may be formed of a Liquid Crystal Display (LCD) or any equivalent, and visually offers a menu, input data, function setting information and any other various information of the mobile device 100 to a user. For instance, the display unit 150 performs a function to output a booting screen, an idle screen, a menu screen, a call screen, or any application execution screens of the mobile device 100. In particular, the display unit 150 displays a UI suitable for manipulating the playback of image content. While selected image content is played, the display unit 150 updates and shows a specific UI for manipulating the playback of the selected image content under the control of the control unit 180 and the display driver 170.

The projector module 160 projects an image, such as a picture, a photo, a video, etc. together with text, onto a surface such as a projection screen or a wall. More particularly, the projector module 160 of exemplary embodiments of the present invention outputs image frames that constitute image content. While any image content is played, the projector module 160 updates and outputs real-time image frames under the control of the control unit 180 and the display driver 170.

The display driver 170 performs a function to control the outputs of the display unit 150 and the projector module 160. The display driver 170 receives image data and a command to output the image data from the control unit 180 and then controls the display unit 150 and the projector module 160 to output the image data. If the control unit 180 is composed of a single processor chip, the display driver 170 may be equipped in the processor chip. More particularly, the mobile device 100 of exemplary embodiments of the present invention has only one display driver 170. Additionally, the display driver 170 has a single output unit, which is connected to both the display unit 150 and the projector module 160. Therefore, while outputting image data through the display unit 150, the display driver 170 may not output any image data through the projector module 160. When image content is played, the display driver 170 updates image frames of the image content by controlling the projector module 160. Also, when receiving a command for a UI update such as an execution time update, the display driver 170 updates a manipulation UI by controlling the display unit 150.

Furthermore, if receiving an image composed of several layers, the display driver 170 may merge all or parts of the received layers under the control of the control unit 180 and then output the merged layers by controlling the display unit 150 or the projector module 160. Also, under the control of the control unit 180, the display driver 170 may output parts of the received layers through the display unit 150 and output the other parts of the received layers through the projector module 160.

The control unit 180 performs a function to control operations of the mobile device 100. The control unit 180 may be composed of a single processor chip or alternatively composed of two or more processor chips (e.g., a main processor chip and an application processor chip). Hereinafter, the operation of the control unit 180 that controls the display driver 170 will be described.

The control unit 180 includes a content playback controller 181 and a UI controller 182. In another exemplary embodiment of the present invention, the control unit 180 may include the content playback controller 181 only.

The content playback controller 181 controls the operations in connection with the playback of image contents. The content playback controller 181 reads data related to image contents stored in the memory unit 140, performs a decoding, and then sends decoded image content data together with an image content output command to the display driver 170. If any image content with a frame rate of 30 frames per second (fps) is to be played, the content playback controller 181 sends a command to update thirty frames per second to the display driver 170.

When a content play command is inputted, the content playback controller 181 sends a UI update start command to the UI controller 182. Then the UI controller 182 receives the UI update start command from the content playback controller 181 and sends a UI update command to the display driver 170. In this exemplary embodiment, when a command to turn off the display unit 150 is inputted, the content playback controller 181 sends a UI update stop command to the UI controller 182.

The UI controller 182 controls the operation in connection with a manipulation UI. While image content is played, the UI controller 182 controls a Graphic User Interface (GUI) for manipulating the image content displayed in the display unit 150. In an exemplary embodiment, such a GUI may be formed of a flash UI, and the UI controller 182 may be formed of a flash engine.

In this exemplary embodiment, the UI controller 182 receives the UI update start command or UI update stop command from the content playback controller 181 and then, based on the received command, sends the UI update command to the display driver 170 or temporarily stops sending the UI update command.

Now, an image output method for the above-discussed mobile device 100 will be described.

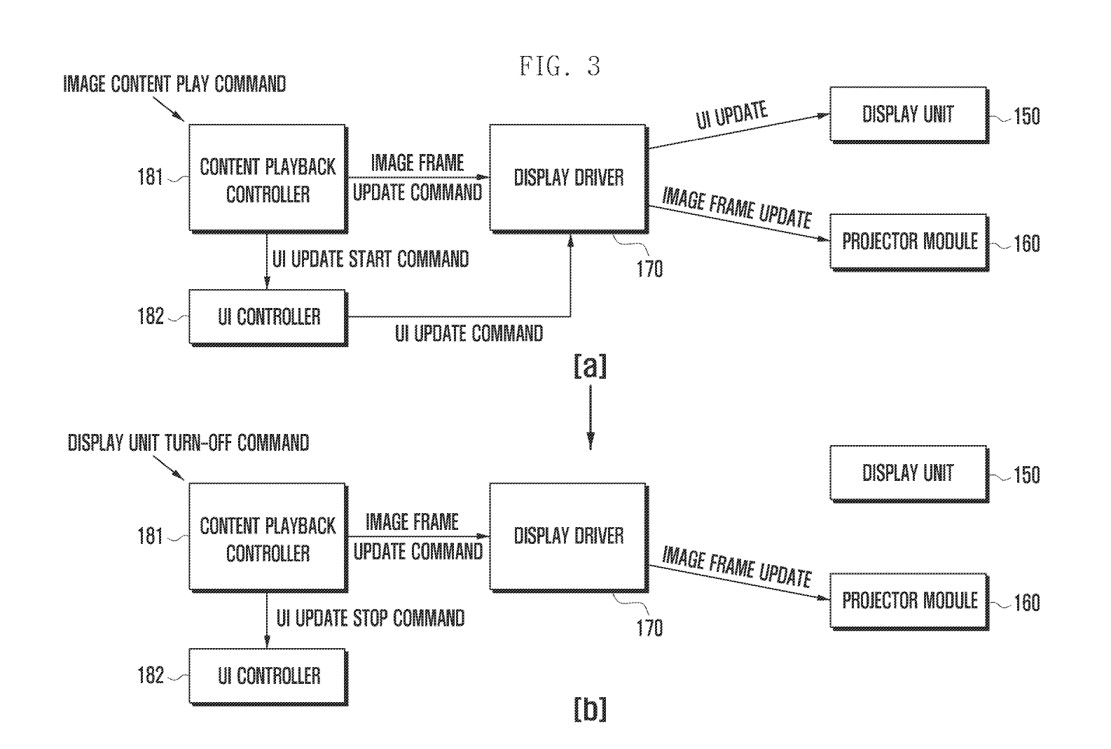

FIG. 3 is a block diagram illustrating a method for outputting images by means of related elements of a mobile device in accordance with an exemplary embodiment of the present invention.

Referring to FIG. 3, a stage [a] shows the operations of the display unit 150, the projector module 160, the display driver 170, the content playback controller 181 and the UI controller 182 when the display unit 150 is in a turned-on state.

At stage [a] of FIG. 3, when receiving an image content play command by a user's input, the content playback controller 181 sends an image frame update command to the display driver 170 and also sends a UI update start command to the UI controller 182.

More specifically, when a user inputs instructions to play selected image content through the input unit 130, the content playback controller 181 receives the image content play command from the input unit 130. Then the content playback controller 181 retrieves selected image content from the memory unit 140, performs a decoding process, and sends image frames of the selected image content to the display driver 170. At this time, the content playback controller 181 further sends the image frame update command to the display driver 170.

Additionally, the content playback controller 181 sends the UI update start command to the UI controller 182. When receiving the UI update start command, the UI controller 182 sends a UI update command together with graphic data of a manipulation UI to the display driver 170. This sending process may be performed periodically after the UI controller 182 receives the UI update start command from the content playback controller 181.

The display driver 170 receives the image frames and the image frame update command from the content playback controller 181 and then updates the received image frames through the projector module 160. Also, whenever receiving the UI update command from the UI controller 182, the display driver 170 updates the manipulation UI by controlling the display unit 150. If the selected image content requires an update of thirty frames per second (i.e., a 30 fps frame rate), the display driver 170 updates thirty frames per second and then outputs them through the projector module 160 or the display unit 150. In this process, since the display driver 170 has the only output unit as discussed above, the display driver 170 cannot simultaneously update both the image frames and the manipulation UI. Therefore, when updating the manipulation UI through the display unit 150, the display driver 170 cannot update the image frames through the projector module 160. If two frames are required for updating the manipulation UI, the display driver 170 outputs only twenty-eight frames among thirty frames in total through the projector module 160 while dropping the remaining two frames.

A stage [b] of FIG. 3 shows the operations of the display unit 150, the projector module 160, the display driver 170, the content playback controller 181 and the UI controller 182 when the display unit 150 is in a turned-off state.

Referring to the stage [b] of FIG. 3, when a given time elapses during the playback of selected image content or when a user inputs a display unit turn-off command, the content playback controller 181 sends the display unit turn-off command to the display driver 170. Then the display driver 170 controls the display unit 150 to be turned off. On the one hand, the content playback controller 181 sends a UI update stop command to the UI controller 182. The UI update stop command may correspond to a UI update pause command. On the other hand, the content playback controller 181 continues to send the image frames and the image frame update command to the display driver 170.

The UI controller 182 receives the UI update stop command from the content playback controller 181 and then stops sending the UI update command and graphic data of the manipulation UI to the display driver 170.

The display driver 170 receives the image frame update command and the image frames from the content playback controller 181 and then updates the received image frames by controlling the projector module 160. At this time, since failing to receive the UI update command from the UI controller 182, the display driver 170 does not perform a process of updating the manipulation UI by controlling the display unit 150. Therefore, the display driver 170 performs only a process of updating the image frames through the projector module 160.

Typically, even while the display unit 150 is turned off, the UI controller 182 continuously sends the UI update command to the display driver 170. Thus, the display driver 170 continues a process of updating the manipulation UI even though the display unit 150 is turned off. However, the UI controller 182 of an exemplary embodiment of the present invention temporarily stops a process of sending the UI update command to the display driver 170 when the display unit 150 is turned off. Therefore, the display driver 170 outputs images to only the projector module 160. Namely, since some frames required for the display unit 150 are used for the projector module 160 in the turned-off state of the display unit 150, the performance of outputting images through the projector module 160 can be improved.

When a user inputs a display unit turn-on command in the display turned-off state, the content playback controller 181 sends the UI update start command to the UI controller 182. Then the UI controller 182 sends the UI update command and graphic data of the manipulation UI to the display driver 170. Meanwhile, the display driver 170 receives the image frames and the image frame update command from the content playback controller 181 and then updates the image frames through the projector module 160. Also, whenever receiving the UI update command from the UI controller 182, the display driver 170 updates the manipulation UI through the display unit 150.

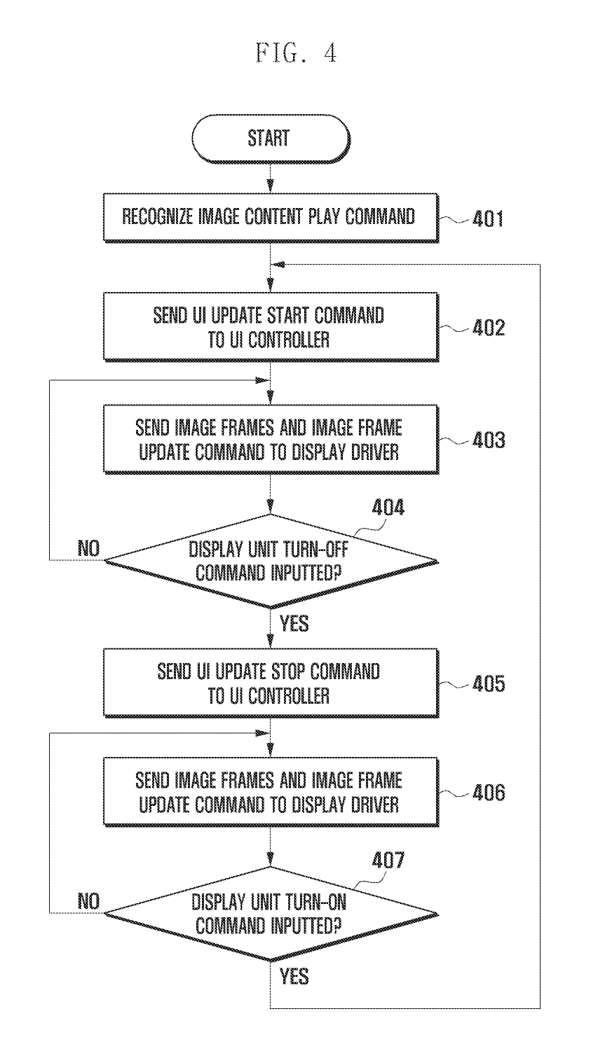

FIG. 4 is a flow diagram illustrating a method for outputting images by means of a content playback controller of a mobile device in accordance with an exemplary embodiment of the present invention.

Referring to FIG. 4, the content playback controller 181 recognizes the image content play command inputted through the input unit 130 in step 401. Namely, when a user inputs instructions to execute selected image content through the input unit 130, the content playback controller 181 receives the image content play command from the input unit 130.

Then the content playback controller 181 sends the UI update start command to the UI controller 182 in step 402. The UI update start command corresponds to a command to enable the UI controller 182 to start a process of sending the UI update command to the display driver 170.

Next, the content playback controller 181 sends image frames and the image frame update command to the display driver 170 in step 403. More specifically, the content playback controller 181 retrieves selected image content from the memory unit 140, performs a decoding process, and sends image frames of the selected image content and the image frame update command to the display driver 170. In another exemplary embodiment, the order of the steps 402 and 403 may be changed. Namely, in this case, the content playback controller 181 sends image frames and the image frame update command to the display driver 170 and then sends the UI update start command to the UI controller 182.

After receiving the UI update start command from the content playback controller 181, the UI controller 182 periodically sends the UI update command and graphic data of the manipulation UI to the display driver 170.

The display driver 170 receives the image frames and the image frame update command from the content playback controller 181 and then updates the received image frames through the projector module 160. Also, whenever receiving the UI update command from the UI controller 182, the display driver 170 updates the manipulation UI by controlling the display unit 150. For instance, the display driver 170 may update a playback time of image content through the display unit 150.

Next, the content playback controller 181 determines whether the display unit turn-off command is inputted in step 404. More specifically, in order to perform the above determination step 404, the content playback controller 181 may determine whether a given time elapses or not in the turned-on state of the display unit 150 or receive user's instructions to turn off the display unit 150 from the input unit 130. In another exemplary embodiment, step 404 may be performed by some element in the control unit 180 other than the content playback controller 181.

If there is no input for the display unit turn-off command, the content playback controller 181 returns to step 403. At this time, the UI controller 182 periodically sends the UI update command and graphic data of the manipulation UI to the display driver 170. Then the display driver 170 updates the received image frames by controlling the projector module 160 and also, whenever receiving the UI update command from the UI controller 182, updates the manipulation UI through the display unit 150.

If the display unit turn-off command is inputted in the above step 404, the content playback controller 181 sends the UI update stop command to the UI controller 182 in step 405. Additionally, the content playback controller 181 continues to send the image frames and the image frame update command to the display driver 170 in step 406.

The UI controller 182 receives the UI update stop command from the content playback controller 181 and then stops a process of sending the UI update command and graphic data of the manipulation UI to the display driver 170. The display driver 170 receives the image frame update command and the image frames from the content playback controller 181 and then updates the received image frames by controlling the projector module 160. Since failing to receive the UI update command from the UI controller 182, the display driver 170 does not perform a process of updating the manipulation UI by controlling the display unit 150 and therefore performs only a process of updating the image frames through the projector module 160.

Next, the content playback controller 181 determines whether the display unit turn-on command is inputted in step 407. In step 407, the content playback controller 181 may receive a user's instructions to turn on the display unit 150 from the input unit 130. If there is no input for the display unit turn-on command, the content playback controller 181 returns to step 406.

If the display unit turn-on command is inputted in step 407, the content playback controller 181 returns to step 402. Therefore, the UI controller 182 again starts to periodically send the UI update command and graphic data of the manipulation UI to the display driver 170. Meanwhile, the display driver 170 continues to update the received image frames by controlling the projector module 160 and also, whenever receiving the UI update command from the UI controller 182, updates the manipulation UI through the display unit 150.

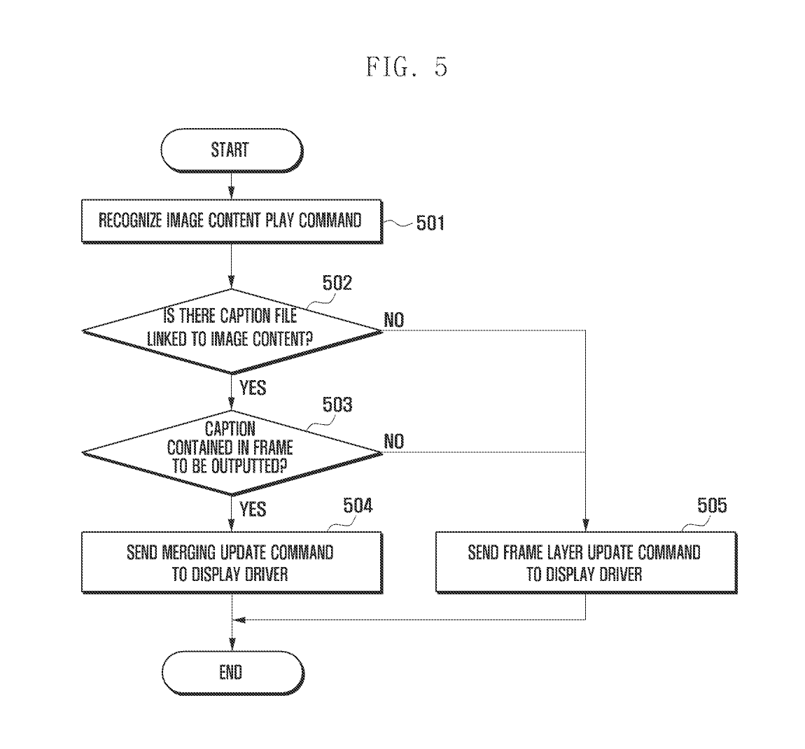

FIG. 5 is a flow diagram illustrating a method for outputting images by means of a content playback controller of a mobile device in accordance with an exemplary embodiment of the present invention. The exemplary embodiment of the present invention shown in FIG. 5 relates to a case of merging layers when a selected image composed of such layers is outputted.

Referring to FIG. 5, at the outset, the content playback controller 181 recognizes the image content play command inputted through the input unit 130 in step 501. Namely, when a user inputs instructions to execute selected image content through the input unit 130, the content playback controller 181 receives the image content play command from the input unit 130.

Next, the content playback controller 181 determines whether there is a caption file linked to selected image content in step 502. Normally, image content with superimposed captions contains a caption file (with an smi extension format, for example). If there is no caption file linked to selected image content, the content playback controller 181 determines that there is no caption file to be outputted, and sends a frame layer update command to the display driver 170 in step 505. Then the display driver 170 updates a frame layer only through the projector module 160 even though a plurality of layers is received.

If it is determined in step 502 that a caption file is linked to selected image content, the content playback controller 181 further determines whether any caption is contained in a current frame to be outputted in step 503. Even though image content has a caption file, each individual frame may or may not have captions. According to an exemplary embodiment of the present invention, each image frame of image content may have an identifier for indicating whether or not captions are present. In this exemplary embodiment, the content playback controller 181 may perform the above determination step 503 by checking for such identifiers. In another exemplary embodiment, the content playback controller 181 may perform the above determination step 503 by comparing a playback time of each image frame with that of the caption file. For instance, the content playback controller 181 finds a time stamp of a current image frame to be outputted, determines whether there is a caption in a corresponding time stamp of a caption file, and then determines whether the current frame contains a caption. If it is determined in the step 503 that there is no caption to be outputted, the content playback controller 181 performs the above-discussed step 505. Namely, the content playback controller 181 sends a frame layer update command to the display driver 170, which updates a frame layer only through the projector module 160.

If it is determined in the step 503 that the current frame to be outputted contains a caption, the content playback controller 181 sends a merging update command to the display driver 170 in step 504. Namely, when there is a caption to be outputted, the content playback controller 181 sends instructions to merge and update a caption layer and a frame layer to the display driver 170. Then the display driver 170 merges the caption layer and the frame layer and also updates them through the projector module 160.

Typically, the display driver 170 does not selectively merge layers, but merges all layers. For instance, even when updating image content with no caption through the projector module 160, the typical display driver 170 merges the caption layer and the frame layer. Unfortunately, a load of this merging process in the display driver 170 may deteriorate the image output performance of the projector module 160 and may consequently cause the degradation in the performance of the mobile device 100.

Exemplary embodiments of the present invention allow the display driver 170 to selectively perform a layer merging process, depending on whether or not captions are present. Therefore, exemplary embodiments of the present invention may reduce undesirable load caused by the layer merging process and may also improve the image output performance of the projector module 160 and the content playback performance of the mobile device 100.

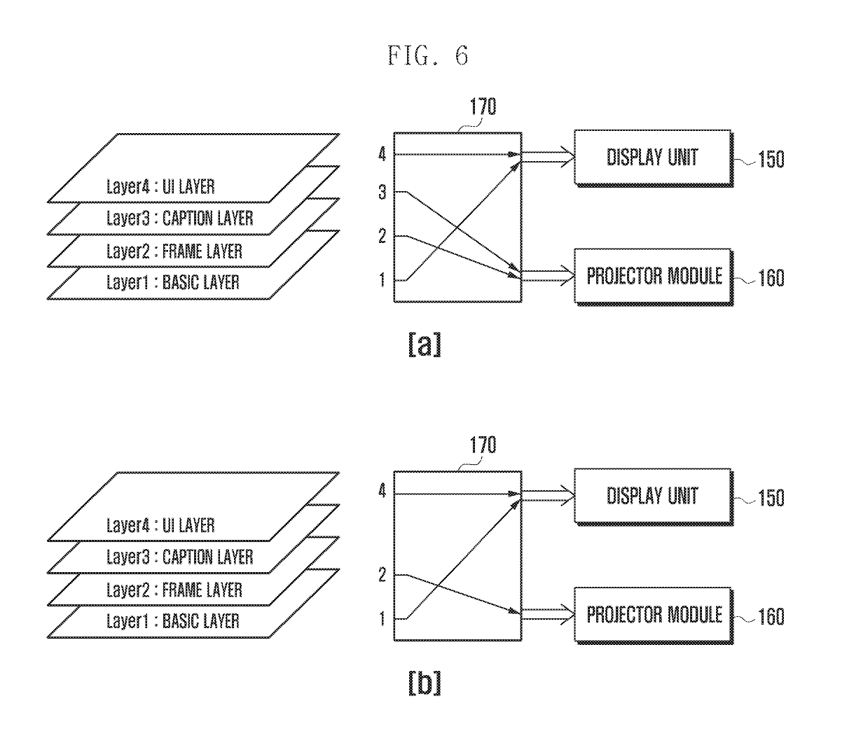

FIG. 6 is a schematic diagram illustrating a method for outputting images with four layers by means of a display driver of a mobile device in accordance with an exemplary embodiment of the present invention.

Although FIG. 6 shows four layers that constitute an image, this is exemplary only and not to be considered as a limitation of the present invention. The number of layers may be varied according to the performance of a processor of the mobile device 100.

Referring to FIG. 6, an image is composed of a layer 1 (i.e., a basic layer), a layer 2 (i.e., a frame layer), a layer 3 (i.e., a caption layer), and a layer 4 (i.e., a UI layer).

The layer 1 is a basic layer that offers the background screen, indicators, etc. in the display unit 150 of the mobile device 100. The layer 2 is a frame layer that offers image frames of image content. The layer 3 is a caption layer that offers captions of image content. The layer 4 is a UI layer that offers the manipulation UI used for manipulating image content and representing a playback time, etc.

A stage [a] of FIG. 6 shows a layer merging form of the display driver 170 when an image with captions is outputted. The display driver 170 merges the layers 1 and 4 and then outputs the merged layers 1 and 4 through the display unit 150. Also, the display driver 170 merges the layers 2 and 3 and then outputs the merged layers 2 and 3 through the projector module 160. Referring to FIG. 2 as well, when receiving the UI update command from the UI controller 182, the display driver 170 merges the layers 1 and 4 and then outputs the merged layers 1 and 4 through the display unit 150. Meanwhile, when receiving image frames and the image frame update command from the content playback controller 181, the display driver 170 merges the layers 2 and 3 and then outputs the merged layers 2 and 3 through the projector module 160.

A stage [b] of FIG. 6 shows a layer merging form of the display driver 170 when an image with no caption is outputted. The display driver 170 merges the layers 1 and 4 and then outputs the merged layers 1 and 4 through the display unit 150, and also outputs the layer 2 only through the projector module 160. Referring to FIG. 2 as well, when receiving the UI update command from the UI controller 182, the display driver 170 merges the layers 1 and 4 and then outputs the merged layers 1 and 4 through the display unit 150. Meanwhile, when receiving image frames and the image frame update command from the content playback controller 181, the display driver 170 outputs the layer 2 only through the projector module 160.

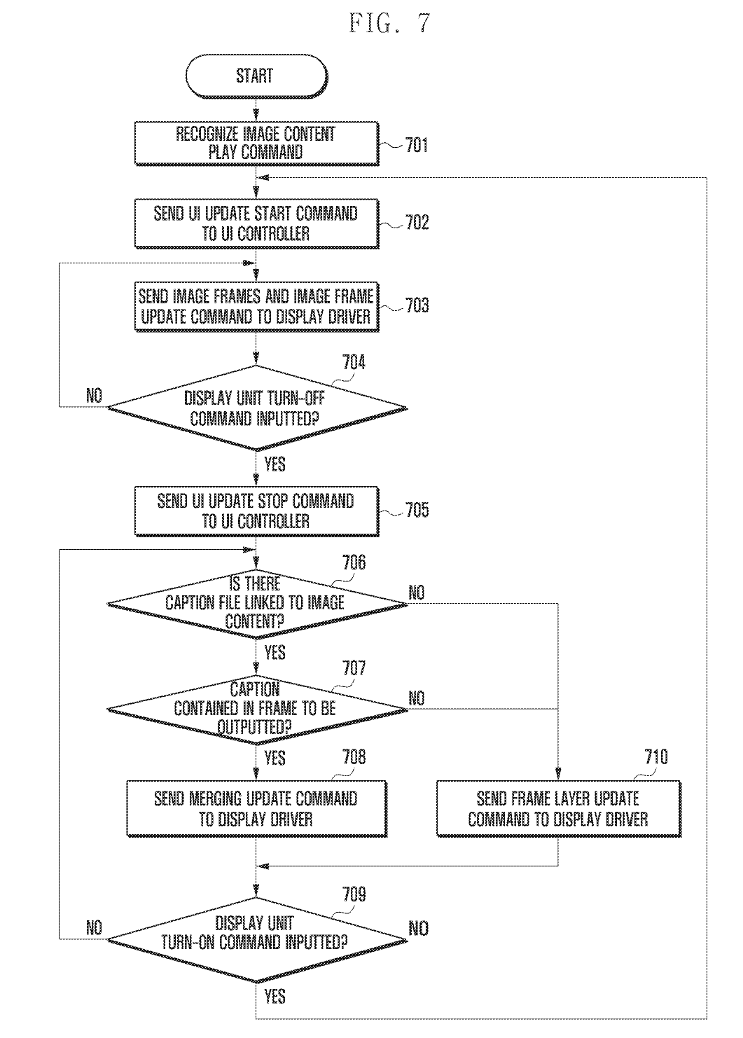

FIG. 7 is a flow diagram illustrating a method for outputting images by means of a content playback controller of a mobile device in accordance with an exemplary embodiment of the present invention.

Referring to FIG. 7, at the outset, the content playback controller 181 recognizes the image content play command inputted through the input unit 130 in step 701. Namely, when a user inputs instructions to execute selected image content through the input unit 130, the content playback controller 181 receives the image content play command from the input unit 130.

Then the content playback controller 181 sends the UI update start command to the UI controller 182 in step 702. Next, the content playback controller 181 sends image frames and the image frame update command to the display driver 170 in step 703. More specifically, the content playback controller 181 retrieves selected image content from the memory unit 140, performs a decoding process, and sends image frames of the selected image content and the image frame update command to the display driver 170.

After receiving the UI update start command from the content playback controller 181, the UI controller 182 periodically sends the UI update command and graphic data of the manipulation UI to the display driver 170. The display driver 170 receives the image frames and the image frame update command from the content playback controller 181 and then updates the received image frames through the projector module 160. Also, whenever receiving the UI update command from the UI controller 182, the display driver 170 updates the manipulation UI by controlling the display unit 150. For instance, the display driver 170 may update a playback time of image content through the display unit 150.

Next, the content playback controller 181 determines whether the display unit turn-off command is inputted in step 704. More specifically, in order to perform the above determination step 704, the content playback controller 181 may determine whether a given time elapses or not in the turned-on state of the display unit 150 or receive a user's instructions to turn off the display unit 150 from the input unit 130.

If there is no input for the display unit turn-off command, the content playback controller 181 returns to step 703. At this time, the UI controller 182 periodically sends the UI update command and graphic data of the manipulation UI to the display driver 170. Then the display driver 170 updates the received image frames by controlling the projector module 160 and also, whenever receiving the UI update command from the UI controller 182, updates the manipulation UI through the display unit 150.

If the display unit turn-off command is inputted in step 704, the content playback controller 181 sends the UI update stop command to the UI controller 182 in step 705. Additionally, the content playback controller 181 continues to send the image frames and the image frame update command to the display driver 170. The UI controller 182 receives the UI update stop command from the content playback controller 181 and then stops a process of sending the UI update command and graphic data of the manipulation UI to the display driver 170. The display driver 170 receives the image frame update command and the image frames from the content playback controller 181 and then updates the received image frames by controlling the projector module 160.

Next, the content playback controller 181 determines whether there is a caption file linked to selected image content in step 706. If there is no caption file linked to selected image content, the content playback controller 181 determines that there is no caption file to be outputted, and sends a frame layer update command to the display driver 170 in step 710.

If it is determined in the step 706 that a caption file is linked to selected image content, the content playback controller 181 further determines whether any caption is contained in a current frame to be outputted in step 707. If it is determined that there is no caption to be outputted, the content playback controller 181 performs the above-discussed step 710. Namely, the content playback controller 181 sends a frame layer update command to the display driver 170, which updates a frame layer only through the projector module 160.

If it is determined in the step 707 that the current frame to be outputted contains a caption, the content playback controller 181 sends a merging update command to the display driver 170 in step 708. Namely, when there is a caption to be outputted, the content playback controller 181 sends instructions to merge and update a caption layer and a frame layer to the display driver 170. Then the display driver 170 merges the caption layer and the frame layer and also updates them through the projector module 160.

Next, the content playback controller 181 determines whether the display unit turn-on command is inputted in step 709. In step 709, the content playback controller 181 may receive a user's instructions to turn on the display unit 150 from the input unit 130. If there is no input for the display unit turn-on command, the content playback controller 181 returns to step 706 while continuing to send image frames and the image frame update command to the display driver 170.

If the display unit turn-on command is inputted in step 709, the content playback controller 181 returns to step 702. Therefore, the UI controller 182 starts again to periodically send the UI update command and graphic data of the manipulation UI to the display driver 170. Meanwhile, the display driver 170 continues to update the received image frames by controlling the projector module 160 and also, whenever receiving the UI update command from the UI controller 182, updates the manipulation UI through the display unit 150.

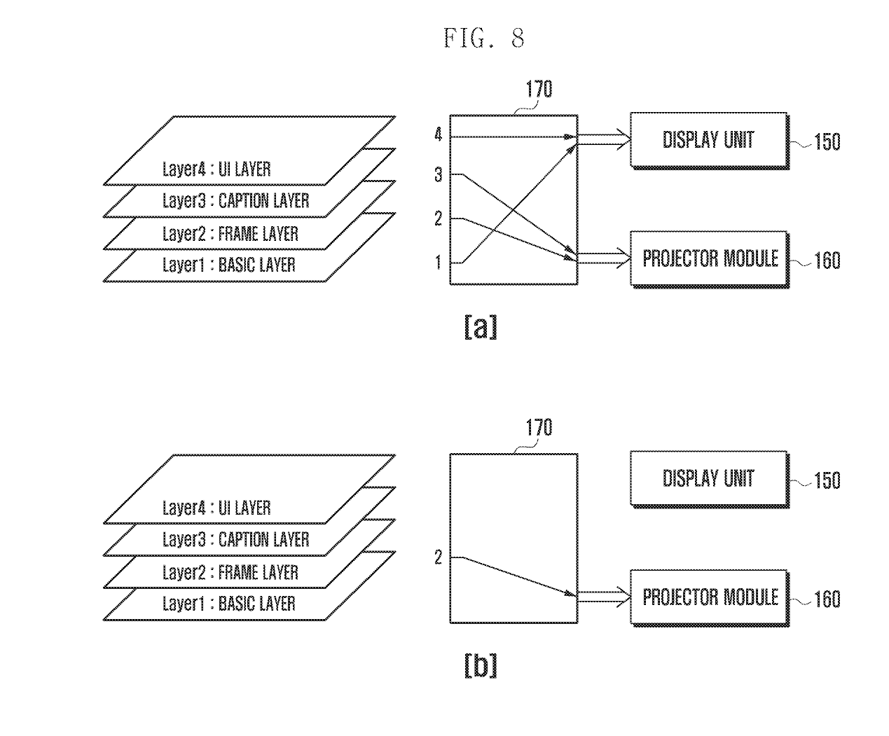

FIG. 8 is a schematic diagram illustrating a method for outputting images with four layers by means of a display driver of a mobile device in accordance with an exemplary embodiment of the present invention.

Like the aforesaid FIG. 6, FIG. 8 exemplarily shows four layers that constitute an image.

Referring to FIG. 8, an image is composed of a layer 1 (i.e., a basic layer), a layer 2 (i.e., a frame layer), a layer 3 (i.e., a caption layer), and a layer 4 (i.e., a UI layer).

A stage [a] of FIG. 8 shows a layer merging form of the display driver 170 when an image with captions is outputted in the turned-on state of the display unit 150. The display driver 170 merges the layers 1 and 4 and then outputs the merged layers 1 and 4 through the display unit 150. Also, the display driver 170 merges the layers 2 and 3 and then outputs the merged layers 2 and 3 through the projector module 160. Referring to FIG. 2 as well, when receiving the UI update command from the UI controller 182, the display driver 170 merges the layers 1 and 4 and then outputs the merged layers 1 and 4 through the display unit 150. Meanwhile, when receiving image frames and the image frame update command from the content playback controller 181, the display driver 170 merges the layers 2 and 3 and then outputs the merged layers 2 and 3 through the projector module 160.

A stage [b] of FIG. 8 shows a layer merging form of the display driver 170 when an image with no caption is outputted in the turned-off state of the display unit 150. The display driver 170 outputs only the layer 2 through the projector module 160. Referring to FIG. 2 as well, when receiving image frames and the image frame update command from the content playback controller 181, the display driver 170 outputs only the layer 2 through the projector module 160. The image frame update command contains instructions to output only the frame layer.

Table 1 given below shows the results of image output executed by a mobile device according the conventional art and the mobile device 100 according to an exemplary embodiment of the present invention. The following results were obtained when image content with a frame rate of 30 fps and no caption was executed for one minute.

TABLE 1

| | Conventional | Mobile device according to |
|---|---|---|
| | mobile device | exemplary embodiment |
| skippedDisplay | 311 | 116 |
| avsyncDrops | 1486 | 433 |
| Decoding Frame Rate | 25/30 | 29/30 |
| Display Frame Rate | 24/30 | 29/30 |

In Table 1, ‘skippedDisplay’ indicates the number of frames dropped when the content playback controller 181 performs a decoding process, and ‘aysyncDrops’ indicates the number of frames dropped without synchronization of audio and video. As shown in Table 1, the number of frames dropped in the mobile device of the exemplary embodiment of the present invention was remarkably reduced in comparison with a case of a conventional mobile device.

Additionally, ‘decoding frame rate’ indicates the number of frames decoded for one second by the content playback controller 181, and ‘display frame rate’ indicates the number of frames outputted through the projector module 160. While twenty-five frames among thirty frames were decoded and twenty-four frames only were outputted in a conventional mobile device, twenty-nine frames among thirty frames were decoded and outputted in the mobile device of the exemplary embodiment of the present invention.

As seen from Table 1, not only the output performance of the projector module 160 but also the decoding performance of the content playback controller 181 was improved. Namely, exemplary embodiments of the present invention may reduce undesirable load when the display driver 170 outputs images through the display unit 150 and the projector module 160, thus wholly enhancing the content playback performance of the mobile device 100. Therefore, exemplary embodiments of the present invention may improve the image output performance of the mobile device 100 with relatively restricted hardware.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A mobile device comprising:
a projector module for outputting image frames that constitute image content;
a display unit for outputting a manipulation User Interface (UI) for manipulating the image content;
a display driver for updating the image frames through the projector module, and for updating the manipulation UI through the display unit whenever a UI update command is received; and
a control unit for sending an image frame update command and the UI update command to the display driver, and for controlling the display driver such that a process of updating the manipulation UI through the display unit is stopped when a turn-off command for the display unit is inputted.

2. The mobile device of claim 1, wherein the control unit stops a process of sending the UI update command to the display driver such that the process of updating the manipulation UI through the display unit is stopped.

3. The mobile device of claim 2, wherein the control unit starts the process of sending the UI update command to the display driver when a turn-on command for the display unit is inputted.

4. The mobile device of claim 1, wherein the control unit includes:
a content playback controller for sending the image frames and the image frame update command to the display driver; and
a UI controller for sending the manipulation UI and the UI update command to the display driver.

5. The mobile device of claim 4, wherein the content playback controller sends a UI update stop command to the UI controller when the turn-off command for the display unit is inputted, and sends a UI update start command to the UI controller when a turn-on command for the display unit is inputted.

6. The mobile device of claim 1, wherein the display driver receives a plurality of layers from the control unit and then, depending on commands of the control unit, updates a frame layer only among the received layers or merges and updates the frame layer and a caption layer among the received layers.

7. The mobile device of claim 6, wherein the control unit determines whether a caption is contained in a selected image to be outputted through the projector module, sends a merging update command for the caption layer and the frame layer to the display driver when the caption is contained, and sends a frame layer update command to the display driver when the caption is not contained.

8. The mobile device of claim 7, wherein the control unit determines whether the caption is contained in the selected image to be outputted through the projector module by determining whether there is a caption file linked to the image content to be played or by determining whether the image frame to be outputted contains the caption.

9. A mobile device comprising:
a projector module for outputting image frames and captions, both of which constitute image content;
a display driver for receiving a plurality of layers, and for updating a frame layer among the received layers or for merging and updating the frame layer and a caption layer among the received layers; and
a control unit for determining whether the caption is contained in a selected image to be outputted through the projector module, for sending a merging update command for the caption layer and the frame layer to the display driver when the caption is contained, and for sending a frame layer update command to the display driver when the caption is not contained.

10. The mobile device of claim 9, wherein the control unit determines whether the caption is contained in the selected image to be outputted through the projector module by determining whether there is a caption file linked to the image content to be played or by determining whether the image frame to be outputted contains the caption.

11. A method of outputting images in a mobile device that includes a projector module, a display unit and a display driver, the method comprising:
sending update commands when recognizing a play command for a selected image content, the sending of the update commands including sending image frames constituting the selected image content, an image frame update command, a manipulation User Interface (UI), and a UI update command to the display driver;
performing an update process at the display driver, the performing of the update process including updating the image frame by controlling the projector module, and updating the manipulation UI by controlling the display unit whenever the UI update command is received; and
when recognizing a turn-off command for the display unit, stopping the updating of the manipulation UI through the display unit by controlling the display driver.

12. The method of claim 11, wherein the mobile device further includes a content playback controller and a UI controller, and
wherein the sending of the update commands includes:
at the content playback controller, when recognizing the play command, sending the image frames and the image frame update command to the display driver, and sending a UI update start command to the UI controller; and
at the UI controller, sending data related to the manipulation UI and the UI update command to the display driver.

13. The method of claim 12, further comprising:
at the content playback controller, when recognizing a turn-off command for the display unit, sending a UI update stop command to the UI controller; and
at the content playback controller, controlling the display driver to update the image frames through the projector module and not to update the manipulation UI through the display unit.

14. The method of claim 12, further comprising:
at the content playback controller, recognizing a turn-on command for the display unit;
sending a UI update start command to the UI controller;
at the UI controller, sending the UI update command to the display driver; and
at the display driver, updating the image frame received from the content playback controller by controlling the projector module, and updating the manipulation UI by controlling the display unit whenever the UI update command is received from the UI controller.

15. A method of outputting images in a mobile device that includes a projector module and a display driver, the method comprising:
determining whether a caption is contained in a selected image to be outputted through the projector module;
sending a merging update command for a caption layer and a frame layer to the display driver when the caption is contained, or sending a frame layer update command to the display driver when the caption is not contained; and
at the display driver, merging and updating the frame layer and the caption layer through the projector module when the merging update command is received, or updating the frame layer only through the projector module when the frame layer update command is received.

16. The method of claim 15, wherein the determining of whether the caption is contained in the selected image to be outputted through the projector module includes determining whether there is a caption file linked to the image content to be played.

17. The method of claim 15, wherein the determining of whether the caption is contained in the selected image to be outputted through the projector module includes determining whether the image frame to be outputted contains the caption.
